(19) United States
(12) Patent Application Publication
(10) Pub. No.: US 2023/0110661 A1
(43) Pub. Date: Apr. 13, 2023

(54) METHOD OF LINKING RECORDS BETWEEN DATABASES

(71) Applicant: T-REX SOLUTIONS, LLC, Greenbelt, MD (US)

(72) Inventor: Tim WITHUM, Greenbelt, MD (US)

(21) Appl. No.: 17/957,263

(22) Filed: Sep. 30, 2022

Related U.S. Application Data
(60) Provisional application No. 63/250,399, filed on Sep. 30, 2021.

(51) Int. Cl. G06F 16/215; G06F 16/2458; G06F 16/27

(52) U.S. Cl. CPC G06F 16/215; G06F 16/27; G06F 16/2468

(57) ABSTRACT

The method of linking records between databases uses pre-processing of a first database to enhance matching speed of a fuzzy matching algorithm for linking records with a second database. In the first database, at least one text field is selected for linking. The set of first entries associated with the selected field is divided into sub-sets. Each sub-set contains at least one of the first entries within a predetermined first edit distance of a first string metric applied to a common text block associated with the sub-set. Second entries of the second database, corresponding to the selected text field of the first database, are matched against a set formed from the common text blocks. Each of the matching ones of the second entries is compared with each of the first entries within the sub-set of the corresponding one of the common text blocks and linked using approximate string matching.

### CROSS-REFERENCE TO RELATED APPLICATION

This application claims the benefit of U.S. Provisional Pat. Application No. 63/250,399, filed on Sep. 30, 2021.

### BACKGROUND

### 1. Field

The disclosure of the present patent application relates to linking records between multiple databases, and particularly to the linking of databases using preprocessing of a reference database.

### 2. Description of the Related Art

Computerized operations rely on extensive amounts of data being stored in databases. Such databases allow data regarding people, products, inventories, etc. to be accessed, searched and sorted rapidly, including cross-referencing of relevant data entries regarding the same entity or subject. Despite their ubiquitous usage, such databases have certain limitations which hinder the user’s ability to find the correct data within the database. Primarily, the actual data within the database is only as accurate as the person who entered the data, or as that found in an original database. Thus, a mistake in the entry of the data into the database may cause a search for data about an entity in the database to miss relevant data about that entity because, for example, a last name of a person was misspelled.

In addition to an inability to easily search for such mis-entered data, other problems may arise in such situations. For example, two separate records for a single entity may exist within the database, since each record may have a different associated name. Such problems multiply when more sophisticated operations are performed with the database, such as attempts to link the records of one database with another database.

In addition to the above, multiple data records may be created for a particular entity as a result of separate data records received from one or more information sources, leading to a problem known as “data fragmentation”. In the case of data fragmentation, a query of the master database may not retrieve all the relevant information about a particular entity. Additionally, the query may miss relevant items of information about the entity due to a typographical error made during data entry, leading to what is referred to as “data inaccessibility”.

For multiple data stores, such as websites or apps each operating their own databases containing a large number of data records, the ability to locate all relevant information about a particular entity within and among the respective databases is very important, but not easily obtained. For example, if a first database has information related to a particular entity, and a second database, similar to the first database, does not have information on this particular entity, then a user searching only the second database would not be able to retrieve the relevant information. Data entry errors, such as those described above, are also multiplied with the addition of additional databases. Additionally, in situations involving multiple information sources, each of the information sources may use slightly different data syntax or formats, which may further complicate the process of finding data among the databases.

To reduce the amount of data that must be reviewed and prevent the user from picking the wrong data record, it is desirable to identify and associate data records from the various information sources that may contain information about the same entity. This process is commonly referred to as “record linkage”. The sub-process of association of multiple records from separate databases that can contain possibly incomplete, complementary, overlapping or conflicting information is referred to as “linkage”. Linkage suffers the problem of having to first assess record similarity (also referred to as “record distance”). In linkage, either a link between the records or a merged master record is formed.

For performing record linkage, conventional systems typically only locate data records which are identical to each other or use a fixed set of rules to determine if two records are identical. Thus, such conventional systems cannot determine if two data records with, for example, slightly different last names, nevertheless contain information about the same entity. Some conventional methods are designed to solve this problem, including phonetic methods and string distance methods. Another approach is to break data up into smaller units or tokens, which can then be matched at a higher rate. Although such techniques provide some improvement in record linkage of identical or related records, none of these methods is capable of perfect record linkage, and the computational time and power can be excessive. Thus, a method of linking records between databases solving these problems is desired.

### SUMMARY

The method of linking records between databases uses pre-processing of a first (or “reference”) database to enhance matching speed of a fuzzy matching algorithm for linking records with a second database. In the first, or reference, database, at least one text field is selected for linking. The set of first entries associated with the selected field is divided into a plurality of, or multiple, sub-sets. Each of the plurality of sub-sets contains at least one of the first entries within a predetermined first edit distance of a first-string metric applied to a common text block associated with that specific sub-set.

Second entries of the second database, which correspond to the selected text field of the first database, are matched against a set formed from the common text blocks. Matching is performed by identifying matching ones of the second entries within a predetermined second edit distance of one of the common text blocks.

Each of the matching ones of the second entries is compared with each of the first entries within the sub-set of the corresponding one of the common text blocks. Approximate string matching is then used to link each of the matching ones of the second entries with a corresponding one of the first entries within the sub-set of the corresponding one of the common text blocks. Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary.

It should be understood that the above may be expanded for multi-variable searching; i.e., rather than selecting only a single text field to be linked, as in the above, a plurality of text fields may be selected. However, unlike the previous embodiment, a set of common text blocks is generated for each selected text field of the first database. Then, an array with elements formed from the common text blocks is generated from the sets of common text blocks. The entries from the second database are linked with the array. This linking may be performed by any suitable type of record linking algorithm. As a non-limiting example, the Fellegi-Sunter algorithm may be used. Once linked, approximate string matching can be applied, as in the previous embodiment, based on the correspondence between the appropriate entries in the first database and the matched entry in the second database. Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary.

In the previous embodiment, the array is formed with the common text blocks as elements. However, as a further alternative, the array may also include elements which are non-textual (e.g., numerical ages). In this case, the usage of string matching for calculating distances at the element level would be replaced by a suitable technique for distance measure which allows for numerical elements, such as, for example, a simple numeric difference. As a further non-limiting example, the Fellegi-Sunter algorithm allows for multiple different element types.

In a further alternative embodiment, a comprehensive database may be used to generate a pre-assembled set of common text blocks. As a non-limiting example, a database may contain a list of last names of every citizen of the United States. This could then be selected as the comprehensive database for generating the pre-assembled set of common text blocks corresponding to last names. In this embodiment, for the chosen comprehensive database, at least one text field is selected (e.g., the text field corresponding to last names). Similar to previous embodiments, a set of comprehensive entries in the comprehensive database associated with the at least one text field is divided into a plurality of sub-sets. Each of the plurality of sub-sets contains at least one of the comprehensive entries within a predetermined comprehensive edit distance of a comprehensive string metric applied to a common text block associated with the sub-set. It should be noted that the predetermined comprehensive edit distance is not rquired to be the same for each common text block; i.e., the value of the distance may be predetermined for each individual common text block, with the predetermined distances preferably being selected to optimize the search time. The common text blocks generated from the comprehensive database may then be used to link records between a first database and a second database.

First entries from the first database corresponding to the selected at least one text field of the comprehensive database are matched with a set of the common text blocks. The matching is performed by identifying matching ones of the first entries within a predetermined first edit distance of one of the common text blocks. Similarly, second entries of the second database corresponding to the selected at least one text field of the comprehensive database are also matched with the set of the common text blocks. The matching of the second entries with the set of the common text blocks is performed by identifying matching ones of the second entries within a predetermined second edit distance of one of the common text blocks. Each of the first entries is compared with each of the second entries matched to the same one of the common text blocks. Then, each of the first entries is linked with a corresponding one of the second entries matched to the same one of the common text blocks using approximate string matching. Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary.

The previous embodiment, in which a comprehensive database is used, may be expanded to multi-variable searching. In this further alternative embodiment, a plurality of text fields are selected in the comprehensive database. A set of comprehensive entries in the comprehensive database associated with each of the selected text fields are divided into multiple sub-sets, where each of the multiple sub-sets corresponding to each of the selected text fields contains at least one of the comprehensive entries within a predetermined comprehensive edit distance of a comprehensive string metric applied to a common text block associated with the respective sub-set. It should be noted that the predetermined comprehensive edit distance is not rquired to be the same for each common text block; i.e., the value of the distance may be predetermined for each individual common text block, with the predetermined distances preferably being selected to optimize the search time. An array with elements formed from the common text blocks of each of the selected text fields is then generated.

First entries of a first database corresponding to each of the selected text fields of the comprehensive database are linked with the array. Similarly, second entries of a second database corresponding to each of the selected text fields of the comprehensive database are linked with the array. As discussed above, this linking may be performed by any suitable type of record linking algorithm. As a non-limiting example, the Fellegi-Sunter algorithm may be used. Each of the first entries are compared with each of the second entries linked to the same one of the elements of the array. Each of the first entries is then linked with a corresponding one of the second entries matched to the same one of the elements of the array using approximate string matching. Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary.

In the embodiments described above, the general concept of “matching” has been described with regard to finding a singular best match. It should, however, be understood that the matching used in the above embodiments may be adapted to finding multiple ranked matches. As a non-limiting example, the top ten closest matches may be found, rather than only the single best match.

These and other features of the present subject matter will become readily apparent upon further review of the following specification.

### DETAILED DESCRIPTION OF THE PREFERRED EMBODIMENTS

The method of linking records between databases uses pre-processing of a first (or “reference”) database in order to enhance matching speed of a fuzzy matching algorithm for linking records with a second database. In the first, or reference, database, at least one text field is selected for linking. As a non-limiting example, the first and second database may contain records of people, with individual text fields for first name, last name and occupation of each person. Using this non-limiting example, the text field corresponding to “Last Name” may be selected.

The set of first entries associated with the selected field is divided into multiple sub-sets. Each sub-set contains at least one of the first entries within a predetermined first edit distance of a first string metric applied to a common text block associated with that sub-set. Corresponding to the above non-limiting example, Table 1 below contains an exemplary set of last names and a corresponding set of common text blocks for the first, or reference, database.

TABLE 1

Example Set of Last Names and Common Text Blocks From First Database

| | |
|---|---|
| Last Name | Common Text Block |
| SMITT | SMXTH |
| SMITH | SMXTH |
| SMOTH | SMXTH |
| SMXTH | SMXTH |
| JONES | JXNES |
| JANES | JXNES |
| JXNES | JXNES |
| GONES | JXNES |
| ANDERSEN | ANDXRSEN |
| ANDRESSEN | ANDXRSEN |
| ANDERSIN | ANDXRSEN |
| ANDXRSEN | ANDXRSEN |

In the above non-limiting example, each of the last names SMITT, SMITH, SMOTH, and SMXTH falls within a predetermined edit distance of the common text block SMXTH. Similar determinations are made in this example for JONES, JANES, JXNES and GONES, which fall within the predetermined edit distance of the common text block JXNES, and for ANDERSEN, ANDRESSEN, ANDERSIN and ANDXRSEN, which fall within the predetermined edit distance of the common text block ANDXRSEN.

Here, the term “string metric” (also sometimes referred to as a “string similarity metric” or “string distance function”) is used in its ordinary sense; i.e., as a metric that measures distance between two text strings for approximate string matching or comparison. It should be understood that any suitable string metric (and corresponding edit distance) may be selected. Non-limiting examples include the Levenshtein distance and the Jaro-Winkler distance. The particular distance may be pre-selected or predetermined by the user based on desired accuracy.

Second entries of the second database, which correspond to the selected text field of the first database, are then matched against a set formed from the common text blocks. Matching is performed by identifying matching ones of the second entries within a predetermined second edit distance of one of the common text blocks. Following the non-limiting example used above, Table 2 shows exemplary last names and occupations stored in the second database, which are to be linked to the last names stored in the first database. In Table 2, examples of gross misspellings (specifically, “SMXTH” and “ANDXRSEN”) are shown. In reality, most entries are likely to be actual names which are relatively similar, or common variants of, a particular name. It should be understood that “SMXTH” and “ANDXRSEN” are used only as examples in Table 2, and no special significance is ascribed to the usage of the “X” in each name (i.e., it is not intended to be a wildcard operator or have any meaning other than as an example of a misspelled or variation of the associated common name).

TABLE 2

Example Set of Last Names and Occupations From Second Database

| | |
|---|---|
| Last Name | Occupation |
| ANDXRSEN | WELDER |
| GONES | WAITRESS |
| SMXTH | COOK |
| ANDRESSEN | CONSTRUCTION |
| JONES | TRAINER |
| JXNES | POLICEMAN |
| ANDERSIN | FIREMAN |
| JANES | PROGRAMMER |
| ANDERSEN | ACCOUNTANT |
| SMITT | ELECTRICIAN |
| SMITH | GARDENER |
| SMOTH | ADMINISTRATOR |

In a conventional fuzzy matching algorithm, each of the twelve last names listed in Table 2 would have to be compared against each of the twelve last names listed in Table 1. In the present method, however, each of the twelve last names listed in Table 2 is only compared against each of the common text blocks. In other words, a string metric is again used to determine which of the twelve last names listed in Table 2 is a predetermined distance from SMXTH, which of the twelve last names listed in Table 2 is a predetermined distance from JXNES, and which of the twelve last names listed in Table 2 is a predetermined distance from ANDXRSEN, by way of the present non-limiting example. This greatly reduces the computational time and energy required in conventional fuzzy matching. As with the choice of the first string metric, any suitable string metric (and corresponding edit distance) may be selected for this stage. Non-limiting examples include the Levenshtein distance and the Jaro-Winkler distance. The particular distance used at this stage may also be pre-selected or predetermined by the user based on desired accuracy.

Each of the matching ones of the second entries is then compared with each of the first entries within the sub-set of the corresponding one of the common text blocks. Following the above non-limiting example, if the fourth entry in Table 2 (“ANDRESSEN”) is found to be within the predetermined edit distance of the common text block ANDXRSEN, approximate string matching may then be used to link ANDRESSEN with the corresponding last name contained with the ANDXRSEN sub-set (i.e., ANDERSEN, ANDRESSEN, ANDERSIN and ANDXRSEN). Thus, the entry for ANDRESSEN in the second database may be linked to the entry for ANDRESSEN contained within the first database. It should be understood that the term “approximate string matching” is a term of art, sometimes referred to as “fuzzy string searching”, which encompasses the string metric methods described above, and may be any suitable technique for finding strings that match a pattern approximately (rather than exactly). Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary.

It should be understood that the common text blocks may, at least initially, be determined randomly or, alternatively, they may be optimized to produce sets of common text blocks that are optimized based on the expected types of searches. For example, they may be more evenly spaced for evenly distributed probabilities of occurrence, or may be more biased patterns that associate more low-match probability entries to a single common text block. It should be further understood that in an embodiment each entry from the selected text field is associated with a common text block. As a further alternative, a hierarchy of common text blocks may be created to optimize the search even further.

As an alternative, the above may be expanded for multi-variable searching; i.e., rather than selecting only a single text field to be linked, as in the above non-limiting example, a plurality of text fields may be selected. As a non-limiting example, the first and second database may contain records of people, with individual text fields for first name, last name and occupation of each person. Using this non-limiting example, the text fields corresponding to “First Name” and “Last Name” may be selected.

The set of first entries associated with the selected fields is divided into sub-sets, as in the previous embodiment, with the sub-sets further including sub-sets for the additional selected fields. In other words, in the previous example, the sub-sets each contained only last names. In the present non-limiting example, there are first sub-sets for first names, and second sub-sets for last names. As in the previous embodiment, each sub-set contains at least one of the first entries within a predetermined first edit distance of a first string metric applied to a common text block associated with the sub-set. Expanding the previous non-limiting example to a further non-limiting example including both first and last names as text fields, Table 3 below contains an exemplary set of first names, an exemplary set of last names, and corresponding sets of common text blocks for the first database.

TABLE 3

Example Set of First Names, Last Names and Common Text Blocks From First Database

| | | | |
|---|---|---|---|
| Last Name | Common Last Name Text Block | First Name | Common First Name Text Block |
| SMITT | SMXTH | JOHN | JXHN |
| SMITH | SMXTH | JOHN | JXHN |
| SMOTH | SMXTH | DANE | DXNE |
| SMXTH | SMXTH | DXNE | DXNE |
| JONES | JXNES | JANE | JXHN |
| JANES | JXNES | JXHN | JXHN |
| JXNES | JXNES | DAN | DXNE |
| GONES | JXNES | DANA | DXNE |

In the above non-limiting example, each of the last names SMITT, SMITH, SMOTH, and SMXTH falls within a predetermined edit distance of the common text block SMXTH. A similar determination is made in this non-limiting example for JONES, JANES, JXNES and GONES, which fall within the predetermined edit distance of the common text block JXNES. In addition to the last names, each of the first names JOHN, JANE and JXHN falls within a predetermined edit distance of the common text block JXHN, and each of the first names DANE, DXNE, DAN and DANA falls within a predetermined edit distance of the common text block DXNE. As in the previous embodiment, it should be understood that any suitable string metric (and corresponding edit distance) may be selected. Non-limiting examples include the Levenshtein distance and the Jaro-Winkler distance. The particular distance may be pre-selected or predetermined by the user based on desired accuracy.

Unlike the previous embodiment, an array with elements formed from the common text blocks may now be generated. Using the above non-limiting example, a non-limiting exemplary array formed from the common text blocks is presented in Table 4 below.

TABLE 4

Array of Common Text Blocks

| # | Last Name Common Text Blocks | First Name Common Text Blocks |
|---|---|---|
| 1 | SMXTH | JXHN |
| 2 | SMXTH | DXNE |
| 3 | JXNES | JXHN |
| 4 | JXNES | DXNE |

Second entries of the second database, which correspond to the selected text field of the first database, are then linked with the array. It should be understood that any suitable type of linking technique may be used. As a non-limiting example, the Fellegi-Sunter algorithm may be used.

As would be recognized by one of ordinary skill in the art, the Fellegi-Sunter algorithm is a probabilistic approach for solving the record linkage problem, and is based on the usage of a decision model. In the Fellegi-Sunter algorithm, records in data sources are assumed to represent observations of entities taken from a particular population. The records are assumed to contain some attributes identifying an individual entity. According to the algorithm, given two or more sources of data, all pairs coming from the Cartesian product of the two sources have to be classified in three independent and mutually exclusive subsets: the set of matches, the set of non-matches and the set of pairs requiring manual review. In order to classify the pairs, the comparisons on common attributes are used to estimate for each pair the probabilities of belonging to both the set of matches and the set of non-matches. The pair classification criteria are based on the ratio between such conditional probabilities. The decision model aims to minimize both the misclassification errors and the probability of classifying a pair as belonging to the subset of pairs requiring manual review. The Fellegi-Sunter algorithm is applied by using field weights based on log likelihood ratios to determine the record similarity.

Following the non-limiting example used above, Table 5 shows exemplary first names, last names and occupations stored in the second database, which are to be linked to the first and last names stored in the first database.

TABLE 5

Example Set of First Names, Last Names and Occupations From Second Database

| | | |
|---|---|---|
| Last Name | First Name | Occupation |
| JONES | JANE | WAITRESS |
| SMITT | JOHN | WELDER |
| SMXTH | DANE | COOK |
| SMITH | JOHN | CONSTRUCTION |
| JANES | JXHN | TRAINER |
| JXNES | DAN | POLICEMAN |
| SMOTH | DANE | FIREMAN |
| GONES | DANA | PROGRAMMER |

In this embodiment, each of the above entries is linked with the common text blocks of the array using, as a non-limiting example, the Fellegi-Sunter algorithm. Thus, in the non-limiting example from Table 5 above, the second entry (SMITT, JOHN) may be linked with the first of the common text blocks of the array of Table 4 (SMXTH, JXHN).

Each of the linked ones of the second entries is then compared with each of the first entries within the sub-set of the corresponding one of the common text blocks of the array. Following the above non-limiting example, the second entry of Table 5 is found to link with the first common text block of the array. The first common text block of the array (SMXTH, JXHN) corresponds to the first two entries of Table 3 (of the first database), thus the second entry of Table 5 need only be compared against these corresponding entries in the first database using approximate string matching to link the appropriate entries. Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary.

Limiting the search as described above (i.e., what is commonly referred to as “blocking”) may, alternatively, be replaced by generating a distance from each common text block, where an exact match would be considered “closest”. By obtaining the distance to all text block possibilities, that value can then be used for that element of the array in the probabilistic algorithm. It should be noted that even if the distance is calculated for all records, particularly in the case of the Fellegi-Sunter algorithm, this approach still remains significantly faster than conventional techniques because the distance remains the same for a single field for all of the values with that same common text block. Thus, the fuzzy match (which is the slow part of the overall method) does not need to be recalculated over and over again for each of the individual records within a common text block.

In the previous embodiment, the array is formed with the common text blocks as elements. However, as a further alternative, the array may also include elements which are non-textual (e.g., numerical ages). In this case, the usage of string matching for calculating distances at the element level would be replaced by a suitable technique for distance measure which allows for numerical elements, such as, for example, a simple numeric difference. As a further non-limiting example, the Fellegi-Sunter algorithm allows for multiple different element types.

In a further alternative embodiment, a comprehensive database may be used to generate a pre-assembled set of common text blocks. As a non-limiting example, a database may contain a list of last names of every citizen of the United States. This could then be selected as the comprehensive database for generating the pre-assembled set of common text blocks corresponding to last names. In this embodiment, for the chosen comprehensive database, at least one text field is selected (e.g., the text field corresponding to last names). Similar to the previous embodiments, a set of comprehensive entries in the comprehensive database associated with the at least one text field is divided into multiple sub-sets. Each of the sub-sets contains at least one of the comprehensive entries within a predetermined comprehensive edit distance of a comprehensive string metric applied to a common text block associated with the respective sub-set. It should be noted that the predetermined comprehensive edit distance is not rquired to be the same for each common text block; i.e., the value of the distance may be predetermined for each individual common text block, with the predetermined distances preferably being selected to optimize the search time. The common text blocks generated from the comprehensive database may then be used to link records between a first database and a second database.

Although a typical comprehensive database may contain the names of all of the people in the United States, or even the entire world, as a very simplified non-limiting example, the resultant set of common text blocks generated from the comprehensive database may include the three common text blocks SMXTH, JXNES and ANDXRSEN. In the first embodiment, these common text blocks were generated from the first database, however, in the present alternative embodiment, these three common text blocks are generated from the comprehensive database before the first or second databases are considered.

First entries from the first database corresponding to the selected at least one text field of the comprehensive database are matched with a set of the common text blocks. The matching is performed by identifying matching ones of the first entries within a predetermined first edit distance of one of the common text blocks. In the non-limiting example shown in Table 6, a set of last names is stored in the first database (which is selected as the text field of interest in this non-limiting example). Each of the last names in the first database is then associated with a corresponding one of the common text blocks from the comprehensive database. Similar to the previous embodiments, this correspondence may be performed by using any suitable type of approximate string matching within a predetermined edit distance from the common text block. Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary.

TABLE 6

Example Set of Last Names and Common Text Blocks From First Database

| | |
|---|---|
| Last Name | Common Text Block |
| SMITT | SMXTH |
| SMITH | SMXTH |
| SMOTH | SMXTH |
| SMXTH | SMXTH |
| JONES | JXNES |
| JANES | JXNES |
| JXNES | JXNES |
| GONES | JXNES |
| ANDERSEN | ANDXRSEN |
| ANDRESSEN | ANDXRSEN |
| ANDERSIN | ANDXRSEN |
| ANDXRSEN | ANDXRSEN |

In the above non-limiting example, each of the last names SMITT, SMITH, SMOTH, and SMXTH falls within a predetermined edit distance of the common text block SMXTH. Similar determinations are made in this example for JONES, JANES, JXNES and GONES, which fall within the predetermined edit distance of the common text block JXNES, and for ANDERSEN, ANDRESSEN, ANDERSIN and ANDXRSEN, which fall within the predetermined edit distance of the common text block ANDXRSEN.

Similarly, second entries of the second database corresponding to the selected at least one text field of the comprehensive database are also matched with the set of the common text blocks. The matching of the second entries with the set of the common text blocks is performed by identifying matching ones of the second entries within a predetermined second edit distance of one of the common text blocks. In the non-limiting example of Table 7 below, the second database contains last names and corresponding occupations. Similar to that described above with respect to the first database, each last name in the second database is compared against the common text blocks from the comprehensive database.

TABLE 7

Example Set of Last Names and Occupations From Second Database

| | | |
|---|---|---|
| Last Name | Common Text Block | Occupation |
| ANDXRSEN | ANDXRSEN | WELDER |
| GONES | JXNES | WAITRESS |
| SMXTH | SMXTH | COOK |
| ANDRESSEN | ANDXRSEN | CONSTRUCTION |
| JONES | JXNES | TRAINER |
| JXNES | JXNES | POLICEMAN |
| ANDERSIN | ANDXRSEN | FIREMAN |
| JANES | JXNES | PROGRAMMER |
| ANDERSEN | ANDXRSEN | ACCOUNTANT |
| SMITT | SMXTH | ELECTRICIAN |
| SMITH | SMXTH | GARDENER |
| SMOTH | SMXTH | ADMINISTRATOR |

Each of the first entries is compared with each of the second entries matched to the same one of the common text blocks. In the non-limiting example given above, in the first database, the first four entries of Table 6 are linked with the common text block SMXTH. In the second database, the third, tenth, eleventh and twelfth entries are linked with the common text block SMXTH. Thus, each of the first four entries of Table 6 must be compared against each of the third, tenth, eleventh and twelfth entries. Then, each of the first entries is linked with a corresponding one of the second entries matched to the same one of the common text blocks using approximate string matching. Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary. As discussed above, using conventional fuzzy matching techniques, the first entry of Table 6, for example, would have to be compared against all twelve entries of Table 7. Using the present technique, the first entry of Table 6 only needs to be compared against four entries in Table 7.

The previous embodiment, in which the comprehensive database is used, may be expanded to multi-variable searching. In this further alternative embodiment, a plurality of text fields are selected in the comprehensive database. As a non-limiting example, the comprehensive database may contain the names of all people in the United States, or even in the entire world, listing both first and last names. In this example, the two text fields of interest are “First Name” and “Last Name”.

A set of comprehensive entries in the comprehensive database associated with each of the selected text fields are divided into multiple sub-sets, where each of the sub-sets corresponding to each of the selected text fields contains at least one of the comprehensive entries within a predetermined comprehensive edit distance of a comprehensive string metric applied to a common text block associated with that sub-set. It should be noted that the predetermined comprehensive edit distance is not rquired to be the same for each common text block; i.e., the value of the distance may be predetermined for each individual common text block, with the predetermined distances preferably being selected to optimize the search time. An array having elements formed from the common text blocks of each of the selected text fields is then generated.

Although a typical comprehensive database may contain the names of all of the people in the United States, or even the entire world, as a very simplified non-limiting example, the resultant set of common text blocks generated from the comprehensive database may include the two common text blocks SMXTH and JXNES for last names, and the two common text blocks JXHN and DXNE for first names. As in the previous embodiment, these common text blocks are generated from the comprehensive database before the first or second databases are considered. Using this simplified non-limiting example, an array of common text blocks from the comprehensive database may be generated, as shown in Table 8 below.

TABLE 8

Array of Common Text Blocks

| # | Last Name Common Text Blocks | First Name Common Text Blocks |
|---|---|---|
| 1 | SMXTH | JXHN |
| 2 | SMXTH | DXNE |
| 3 | JXNES | JXHN |
| 4 | JXNES | DXNE |

First entries of a first database corresponding to each of the selected text fields of the comprehensive database are linked with the array. It should be understood that any suitable type of linking technique may be used. As a non-limiting example, the Fellegi-Sunter algorithm may be used. Table 9 presents an exemplary first database, including first names and last names, and showing the linkage between each name entry and its corresponding common text block contained within the array.

TABLE 9

Example Set of First Names, Last Names and Common Text Blocks From First Database

| | | | |
|---|---|---|---|
| Last Name | Common Last Name Text Block | First Name | Common First Name Text Block |
| SMITT | SMXTH | JOHN | JXHN |
| SMITH | SMXTH | JOHN | JXHN |
| SMOTH | SMXTH | DANE | DXNE |
| SMXTH | SMXTH | DXNE | DXNE |
| JONES | JXNES | JANE | JXHN |
| JANES | JXNES | JXHN | JXHN |
| JXNES | JXNES | DAN | DXNE |
| GONES | JXNES | DANA | DXNE |

In the above non-limiting example, each of the last names SMITT, SMITH, SMOTH, and SMXTH falls within a predetermined string comparison distance, for example, of the common text block SMXTH. A similar determination is made in this example for JONES, JANES, JXNES and GONES, which fall within the predetermined string comparison distance of the common text block JXNES. In addition to the last names, each of the first names JOHN, JANE and JXHN falls within a predetermined string comparison distance of the common text block JXHN, and each of the first names DANE, DXNE, DAN and DANA falls within a predetermined string comparison distance of the common text block DXNE.

Similarly, second entries of a second database corresponding to each of the selected text fields of the comprehensive database are linked with the array of common text blocks. It should be understood that any suitable type of linking technique may be used. As a non-limiting example, the Fellegi-Sunter algorithm may be used. Following the non-limiting example used above, Table 10 shows exemplary first names, last names and occupations stored in the second database, and the corresponding common text blocks found within the array.

TABLE 10

Example Set of First Names, Last Names and Occupations From Second Database

| | | | | |
|---|---|---|---|---|
| Last Name | Common Last Name Text Block | First Name | Common First Name Text Block | Occupation |
| GONES | JXNES | DANA | DXNE | PROGRAMMER |
| SMXTH | SMXTH | DXNE | DXNE | CONSTRUCTION |
| SMITT | SMXTH | JOHN | JXHN | WAITRESS |
| JXNES | JXNES | DAN | DXNE | FIREMAN |
| JONES | JXNES | JANE | JXHN | TRAINER |
| SMITH | SMXTH | JOHN | JXHN | WELDER |
| SMOTH | SMXTH | DANE | DXNE | COOK |
| JANES | JXNES | JXHN | JXHN | POLICEMAN |

As in the previous embodiment, each of the first entries are compared with each of the second entries linked to the same one of the common text blocks of the array. Each of the first entries is then linked with a corresponding one of the second entries matched to the same one of the common text blocks of the array using approximate string matching. Preferably, the approximate string matching technique is the same string matching method used to create the common text blocks, however, it is should be understood that this is not necessarily the case. If the two methods are not the same, there is a potential for introducing errors, thus usage of the same approximate string matching technique is preferred, though not strictly necessary.

In the embodiments described above, the general concept of “matching” has been described with regard to finding a singular best match. It should, however, be understood that the matching used in the above embodiments may be adapted to finding multiple ranked matches. As a non-limiting example, the top ten closest matches may be found, rather than only the single best match.

It should be understood that the above processes and calculations may be performed by any suitable computer system. Data may be entered into the computer system via any suitable type of user interface, and may be stored in computer readable memory, which may be any suitable type of computer readable and programmable memory, and is preferably a non-transitory, computer readable storage medium. Calculations may be performed by a processor, which may be any suitable type of computer processor, and may be displayed to the user on one or more displays, each of which may be any suitable type of computer display.

The processor may be associated with, or incorporated into, any suitable type of computing device, for example, a personal computer or a programmable logic controller. For each display(s), the processor, the memory and any associated computer readable recording media may be in communication with one another by any suitable type of data bus, as is well known in the art.

Non-limiting examples of computer-readable recording media include non-transitory storage media, a magnetic recording apparatus, an optical disk, a magneto-optical disk, and/or a semiconductor memory (for example, RAM, ROM, etc.). Non-limiting examples of magnetic recording apparatus that may be used in addition to the main memory, or in place of the main memory, include a hard disk device (HDD), a flexible disk (FD), and a magnetic tape (MT). Non-limiting examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

It is to be understood that the method of linking records between databases is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A method of linking records between databases, comprising the steps of:
selecting at least one text field in a first database;
dividing a set of first entries in the first database associated with the at least one text field into a plurality of sub-sets, wherein each of the plurality of sub-sets contains at least one of the first entries within a predetermined first edit distance of a first string metric applied to a common text block associated with that sub-set;
matching second entries of a second database corresponding to the selected at least one text field of the first database with a set of the common text blocks, wherein the matching of the second entries with the set of the common text blocks identifies matching ones of the second entries within a predetermined second edit distance of one of the common text blocks;
comparing each of the matching ones of the second entries with each of the first entries within the sub-set of the corresponding one of the common text blocks; and
linking each of the matching ones of the second entries with a corresponding one of the first entries within the sub-set of the corresponding one of the common text blocks using approximate string matching.

2. The method of linking records between databases as recited in claim 1, wherein:
the step of selecting the at least one text field in the first database comprises selecting a plurality of text fields in the first database;
the step of dividing the set of first entries in the first database comprises dividing the set of first entries in the first database associated with each of the text fields into the plurality of sub-sets associated with each of the text fields, wherein each of the plurality of sub-sets contains at least one of the first entries within the predetermined first edit distance of the first string metric applied to the common text block associated with the sub-set associated with the corresponding one of the text fields;
the method further comprises generating an array with elements respectively comprising the common text blocks of each of the selected text fields following the step of dividing the set of first entries in the first database;
the step of matching the second entries of the second database comprises linking the second entries of the second database corresponding to each of the selected text fields of the first database with the array; and
the step of comparing each of the matching ones of the second entries comprises comparing each of the matching ones of the second entries with each of the first entries within the sub-set of the corresponding one of the common text blocks of the corresponding one of the elements of the array.

3. The method of linking records between databases as recited in claim 1, wherein the first edit distance is selected from the group consisting of the Levenshtein distance and the Jaro-Winkler distance.

4. The method of linking records between databases as recited in claim 1, wherein the second edit distance is selected from the group consisting of the Levenshtein distance and the Jaro-Winkler distance.

5. A method of linking records between databases, comprising the steps of:
selecting a plurality of text fields in a first database;
dividing a set of first entries in the first database associated with each of the text fields into a plurality of sub-sets associated with each of the text fields, wherein each of the plurality of sub-sets contains at least one of the first entries within a predetermined first edit distance of a first string metric applied to a common text block associated with the sub-set associated with the corresponding one of the text fields;
generating an array with elements respectively comprising the common text blocks of each of the selected text fields;
linking second entries of a second database corresponding to each of the selected text fields of the first database with the array;
comparing each of the matching ones of the second entries with each of the first entries within the sub-set of the corresponding one of the common text blocks of the corresponding one of the elements of the array; and
linking each of the matching ones of the second entries with a corresponding one of the first entries within the sub-set of the corresponding one of the common text blocks for each of the text fields using approximate string matching.

6. The method of linking records between databases as recited in claim 5, wherein the step of linking the second entries of the second database corresponding to each of the selected text fields of the first database with the array is performed using the Fellegi-Sunter algorithm.

7. The method of linking records between databases as recited in claim 5, wherein the first edit distance is selected from the group consisting of the Levenshtein distance and the Jaro-Winkler distance.

8. A method of linking records between databases, comprising the steps of:
selecting at least one text field in a comprehensive database;
dividing a set of comprehensive entries in the comprehensive database associated with the at least one text field into a plurality of sub-sets, wherein each of the plurality of sub-sets contains at least one of the comprehensive entries within a predetermined comprehensive edit distance of a comprehensive string metric applied to a common text block associated with that sub-set;
matching first entries of a first database corresponding to the selected at least one text field of the comprehensive database with a set of the common text blocks, wherein the matching of the first entries with the set of the common text blocks identifies matching ones of the first entries within a predetermined first edit distance of one of the common text blocks;
matching second entries of a second database corresponding to the selected at least one text field of the comprehensive database with the set of the common text blocks, wherein the matching of the second entries with the set of the common text blocks identifies matching ones of the second entries within a predetermined second edit distance of one of the common text blocks;
comparing each of the first entries with each of the second entries matched to the same one of the common text blocks; and
linking each of the first entries with a corresponding one of the second entries matched to the same one of the common text blocks using approximate string matching.

9. The method of linking records between databases as recited in claim 8, wherein:
the step of selecting the at least one text field in the comprehensive database comprises selecting a plurality of text fields in the comprehensive database;
the step of dividing the set of comprehensive entries in the comprehensive database comprises dividing the set of comprehensive entries in the comprehensive database associated with each of the text fields into the plurality of sub-sets associated with each of the text fields, wherein each of the plurality of sub-sets contains at least one of the comprehensive entries within the predetermined comprehensive edit distance of the comprehensive string metric applied to the common text block associated with the sub-set associated with the corresponding one of the text fields;
the method further comprises generating an array with elements respectively comprising the common text blocks of each of the selected text fields following the step of dividing the set of comprehensive entries in the comprehensive database;
the step of matching the first entries of the first database comprises linking the first entries of the first database corresponding to each of the selected text fields of the first database with the array; and
the step of matching the second entries of the second database comprises linking the second entries of the second database corresponding to each of the selected text fields of the second database with the array.

10. A method of linking records between databases, comprising the steps of:
selecting a plurality of text fields in a comprehensive database;
dividing a set of comprehensive entries in the comprehensive database associated with each of the selected text fields into a plurality of sub-sets, wherein each of the plurality of sub-sets corresponding to each of the selected text fields contains at least one of the comprehensive entries within a predetermined comprehensive edit distance of a comprehensive string metric applied to a common text block associated with that sub-set;
generating an array with elements respectively comprising the common text blocks of each of the selected text fields;
linking first entries of a first database corresponding to each of the selected text fields of the comprehensive database with the array;
linking second entries of a second database corresponding to each of the selected text fields of the comprehensive database with the array;
comparing each of the first entries with each of the second entries linked to the same one of the elements of the array; and
linking each of the first entries with a corresponding one of the second entries linked to the same one of the elements of the array using approximate string matching.

11. The method of linking records between databases as recited in claim 9, wherein the step of linking the first entries of the first database corresponding to each of the selected text fields of the comprehensive database with the array is performed using the Fellegi-Sunter algorithm.

12. The method of linking records between databases as recited in claim 9, wherein the step of linking the second entries of the second database corresponding to each of the selected text fields of the comprehensive database with the array is performed using the Fellegi-Sunter algorithm.
